(19) United States
(12) Patent Application Publication
(10) Pub. No.: US 2022/0212387 A1
(43) Pub. Date: Jul. 7, 2022

(54) INJECTION APPARATUS AND RELATED METHODS

(71) Applicant: Niigon Machines Ltd., Vaughan (CA)

(72) Inventors: Martin Kestle, Everett (CA); Brandon Winkels, Bolton (CA); Robert D. Schad, Toronto (CA); Carsten Link, Burlington (CA); Marc Ricke, Guelph (CA); Mitchell Cross, Toronto (CA); Eeshaan Manjunaath Patil, Toronto (CA)

(21) Appl. No.: 17/704,128

(22) Filed: Mar. 25, 2022

Related U.S. Application Data
(63) Continuation of application No. PCT/CA2020/051286, filed on Sep. 25, 2020.
(60) Provisional application No. 62/906,168, filed on Sep. 26, 2019.

(51) Int. Cl. B29C 45/77; B29C 45/50; B29C 45/83

(52) U.S. Cl. CPC B29C 45/77; B29C 2945/76859; B29C 45/83; B29C 2045/5024; B29C 2045/5028; B29C 2045/5032; B29C 2945/76006; B29C 2945/7602; B29C 2945/76096; B29C 2945/76197; B29C 2945/76214; B29C 2945/76498; B29C 2945/76511; B29C 2945/76692; B29C 2945/76943; B29C 45/5008

(57) ABSTRACT

An injection apparatus includes (a) a barrel; (b) a nozzle at a front end of the barrel; (c) a screw in the barrel; and (d) a drive assembly including: (i) a housing having a front end coupled to the barrel; (ii) a spindle in the housing and fixed to the screw; (iii) a first motor in the housing and having a hollow first rotor through which the spindle passes. The first rotor is coupled to the spindle for driving rotation of the screw about the axis. The drive assembly further includes (iv) a second motor in the housing axially rearward of the first motor. The second motor has a hollow second rotor through which the spindle passes. The second rotor is coupled to the spindle for translating the screw along the axis in response to rotation of the second rotor relative to the spindle.

This application is a continuation of International Application Ser. No. PCT/CA2020/051286, filed Sep. 25, 2020, which claims the benefit of Provisional Application Ser. No. 62/906,168, filed Sep. 26, 2019, the entire contents of which are hereby incorporated by reference.

### FIELD

The specification relates generally to apparatuses and methods associated with plasticizing and injecting mold material into a mold of an injection molding machine.

### BACKGROUND

U.S. Pat. No. 5,540,495 A (Pickel) relates to an extruder screw drive having a first and a second motor, a screw mechanism connected to the first motor and to the extruder screw for translating it in the extrusion cylinder, and a slide mechanism connected to the second motor and to the extruder screw for rotating it in the extrusion cylinder. The screw mechanism and the slide mechanism are coaxial and partially fit into one another to provide an axially compact arrangement. The motors can be hollow shaft electric motors axially aligned together, and pressure regulated hydraulic axial force can be added to the extruder screw during plasticating as it retracts due to increased volume of plastic at an output end of the extrusion cylinder.

U.S. Pat. App. Pub. No. 2004/0173925 A1 (Melkus) relates to a control method for controlling the back pressure in an injection molding machine which includes a first motor that axially displaces a screw and a second motor that turns the screw, whereby both motors act upon a common shaft. In order to control the back pressure, a speed value for controlling the second motor is furnished as a rotational speed input value to a control circuit for controlling the speed or rotation speed of the first motor. The back pressure is thus controlled in dependence on a pressure differential via the difference in rotation speeds of both motors.

### SUMMARY

The following summary is intended to introduce the reader to various aspects of the applicant's teaching, but not to define any invention.

According to some aspects, an injection apparatus for an injection molding machine includes: (a) a barrel extending along an axis; (b) a nozzle at a front end of the barrel for discharging melt; (c) a screw in the barrel, the screw rotatable about and translatable along the axis; and (d) a drive assembly for driving translation and rotation of the screw. The drive assembly includes: (i) a housing having a front end coupled to the barrel and a rear end axially opposite the front end; (ii) a spindle in the housing, the spindle extending along the axis and fixed to the screw; (iii) a first motor in the housing, the first motor having a hollow first rotor through which the spindle passes, the first rotor rotationally fixed to the spindle for driving rotation of the screw about the axis, and the spindle axially translatable relative to the first rotor for accommodating translation of the screw along the axis; and (iv) a second motor in the housing axially rearward of the first motor toward the rear end of the housing, the second motor having a hollow second rotor through which the spindle passes, the second rotor coupled to the spindle and rotatable relative to the spindle in a rotational first direction for advancing the screw along the axis and in a rotational second direction opposite the first direction for retracting the screw along the axis.

In some examples, the spindle has an internal first conduit extending between a first conduit intake end open to a rear of the spindle for receiving lubricant and a first conduit discharge end open to a first interface between the spindle and the first rotor for discharging the lubricant into the first interface.

In some examples, the spindle has an internal second conduit extending between a second conduit intake end open to a rear of the spindle for receiving lubricant and a second conduit discharge end open to a second interface between the spindle and the second rotor for discharging the lubricant into the second interface.

In some examples, the spindle comprises a spline portion extending along the axis and the first rotor comprises a spline nut coupled to the spline portion of the spindle. In some examples, the spindle comprises a ball screw portion extending along the axis and the second rotor comprises a ball nut coupled to the ball screw portion.

In some examples, the drive assembly includes a bearing assembly mounted between the second rotor and the housing adjacent the rear end of the housing, the bearing assembly accommodating rotation of the second rotor relative to the housing and transferring at least a portion of a rearwardly directed axial force exerted on the second rotor to the housing.

In some examples, each of the first motor and the second motor is axially fixed relative to the housing.

In some examples, the drive assembly includes a rotary first encoder having a first encoder disc mounted coaxially to the first rotor for measuring rotational displacement of the first rotor relative to the housing.

In some examples, the drive assembly includes a rotary second encoder having a second encoder disc mounted coaxially to the second rotor for measuring rotational displacement of the second rotor relative to the housing.

In some examples, the housing has a generally sealed interior, and the spindle, the first motor, and the second motor are generally enclosed in the sealed interior.

According to some aspects, an injection apparatus for an injection molding machine includes: (a) a barrel extending along an axis; (b) a nozzle at a front end of the barrel for discharging melt; (c) a screw in the barrel, the screw rotatable about and translatable along the axis; (d) a shot chamber in the barrel axially intermediate the screw and the nozzle for holding melt; (e) a drive assembly for driving translation and rotation of the screw. The drive assembly includes: (i) a housing having a front end coupled to the barrel; (ii) a spindle in the housing, the spindle extending along the axis and fixed to the screw; (iii) a first motor in the housing, the first motor having a hollow first rotor through which the spindle passes, the first rotor rotationally fixed to the spindle for driving rotation of the screw about the axis, and the spindle axially translatable relative to the first rotor for accommodating translation of the screw along the axis; (iv) a second motor in the housing, the second motor having a hollow second rotor through which the spindle passes, the second rotor coupled to the spindle and rotatable relative to the spindle in a rotational first direction for advancing the screw along the axis and in a rotational second direction opposite the first direction for retracting the screw along the axis. The injection apparatus further includes: (f) a controller configured to operate the drive assembly to, for each injection cycle: (i) apply a holding torque to the first rotor for inhibiting rotation of the screw about the axis relative to the housing; (ii) during (i), apply an injection torque to the second rotor in the first direction to exert an axial force on the spindle for urging the screw to advance toward the nozzle; (iii) during (ii), determine an injection pressure value based on the holding torque, the injection pressure value corresponding to a reactionary pressure of melt in the shot chamber during application of the holding and injection torque; and (iv) adjust the injection torque to bring the injection pressure value toward a target pressure value, the target pressure value corresponding to a target pressure for the melt in the shot chamber during injection of the melt into a mold.

In some examples, the controller is operable to determine the holding torque based on an electrical current being drawn by the first motor to apply the holding torque.

In some examples, the controller is further operable to, prior to (iv), compare the injection pressure value to the target pressure value, and in response to determining that the injection pressure value corresponds to the target pressure value, maintain the holding and injection torques and repeat (ii) and (iii), and in response to determining that the injection pressure value does not correspond to the target pressure value, proceed to (iv).

In some examples, the controller is further operable to determine the target pressure value based on an axial position of the screw.

In some examples, the controller is further operable to determine the axial position of the screw based on output from a first encoder for measuring rotational displacement of the first rotor relative to the housing and a second encoder for measuring rotational displacement of the second rotor relative to the housing.

In some examples, the controller is operable to, after (iv), repeat (ii) to (iv) until detection of one or more termination conditions.

According to some aspects, a method of operating an injection apparatus drive assembly to regulate melt injection pressure includes: (a) applying a holding torque to a hollow first rotor to inhibit rotation of a spindle about an axis, the spindle passing through the first rotor along the axis and fixed to an injection screw; (b) during (a), applying an injection torque to a hollow second rotor to exert an axial force on the spindle, the spindle passing through the second rotor along the axis and the axial force urging the injection screw to advance toward a nozzle; (c) during (b), determining an injection pressure value based on the holding torque, the injection pressure value corresponding to a reactionary pressure of melt in a shot chamber axially intermediate the screw and the nozzle during application of the holding and injection torque; and (d) adjusting the injection torque to bring the injection pressure value toward a target pressure value, the target pressure value corresponding to a target pressure for the melt in the shot chamber during injection of the melt into a mold.

In some examples, (c) includes determining the holding torque based on an electrical current being drawn to apply the holding torque.

In some examples, the method further includes, prior to (d), comparing the injection pressure value to the target pressure value, and in response to determining that the injection pressure value corresponds to the target pressure value, maintaining the holding and injection torques and repeating (b) and (c), and in response to determining that the injection pressure value does not correspond to the target pressure value, proceeding to (d).

In some examples, the method further includes determining the target pressure value based on an axial position of the screw.

In some examples, the method further includes determining the axial position of the screw based on output from a first encoder for measuring rotational displacement of the first rotor relative to the housing and a second encoder for measuring rotational displacement of the second rotor relative to the housing.

In some examples, the method further includes, after (d), repeating (b) to (d) until detection of one or more termination conditions.

According to some aspects, a method of operating an injection apparatus drive assembly to regulate melt plasticization pressure includes: (a) applying a plasticization torque to a hollow first rotor to drive rotation of a spindle about an axis for filling a shot chamber with melt, the spindle passing through the first rotor along the axis and fixed to an injection screw; (b) during (a), applying a retraction torque to a hollow second rotor to control retraction of the spindle along the axis during application of the plasticization torque, the spindle passing through the second rotor along the axis; and (c) monitoring and adjusting the plasticization torque and the retraction torque to maintain a target back pressure of melt in the shot chamber during rotation and retraction of the spindle.

According to some aspects, an injection apparatus for an injection molding machine includes: (a) a barrel extending along an axis; (b) a nozzle at a front end of the barrel for discharging melt; (c) a screw in the barrel, the screw rotatable about and translatable along the axis; and (d) a drive assembly for driving translation and rotation of the screw. The drive assembly includes: (i) a housing having a front end coupled to the barrel; (ii) a spindle in the housing, the spindle extending along the axis and fixed to the screw; (iii) a first motor in the housing, the first motor having a hollow first rotor through which the spindle passes, the first rotor rotationally fixed to the spindle for driving rotation of the screw about the axis, and the spindle axially translatable relative to the first rotor for accommodating translation of the screw along the axis; (iv) a rotary first encoder having a first encoder disc mounted coaxially to the first rotor for measuring rotational displacement of the first rotor relative to the housing; (v) a second motor in the housing, the second motor having a hollow second rotor through which the spindle passes, the second rotor coupled to the spindle and rotatable relative to the spindle in a rotational first direction for advancing the screw along the axis and in a rotational second direction opposite the first direction for retracting the screw along the axis; and (vi) a rotary second encoder having a second encoder disc mounted coaxially to the second rotor for measuring rotational displacement of the second rotor relative to the housing.

In some examples, at least one of the first encoder disc and the second encoder disc is generally annular, and the spindle passes through the at least one of the first encoder disc and the second encoder disc.

In some examples, the injection apparatus further includes a controller configured to, during each injection cycle: (i) determine a first rotor rotational displacement of the first rotor over a time interval based on output from the first encoder; (ii) determine a second rotor rotational displacement over the time period based on output from the second encoder; and (iii) determine an axial displacement of the screw based on a differential between the first rotor rotational displacement and the second rotor rotational displacement.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic elevation view of an example injection molding machine;

FIG. 2 is a perspective view of an injection apparatus of the machine of FIG. 1;

FIG. 3 is a cross-sectional view of the injection apparatus of FIG. 2, taken along line 3-3 of FIG. 2 and showing a screw of the injection apparatus in an advanced configuration;

FIG. 4 is a cross-sectional view like that of FIG. 3, and showing the screw in a retracted configuration;

FIG. 5 is an enlarged view of a portion of FIG. 3;

FIG. 6 is a flow chart showing an example method of regulating melt injection pressure;

FIG. 7 is a flow chart showing an example method of regulating melt plasticization pressure; and

FIG. 8 is another example of an injection apparatus suitable for use with the machine of FIG. 1.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

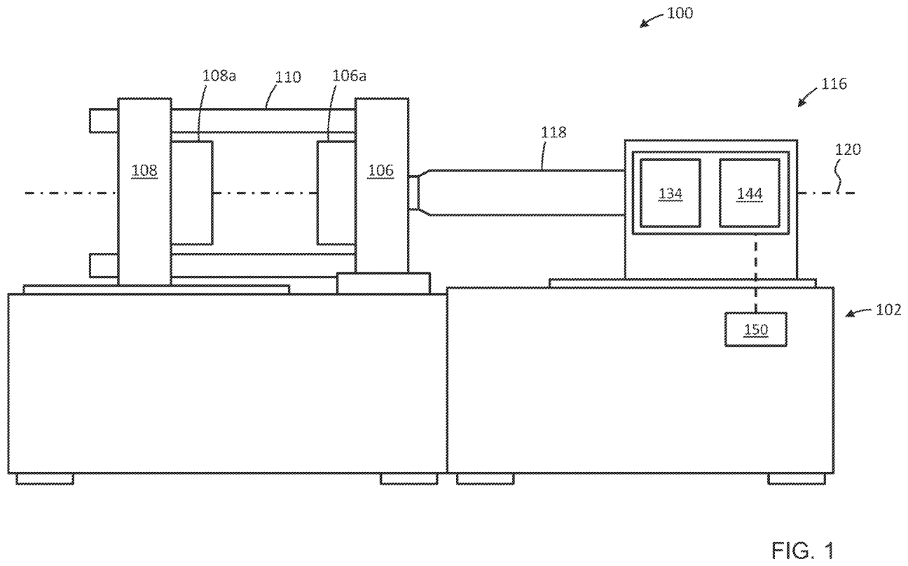

Referring to FIG. 1, an example injection molding machine 100 is shown. The machine 100 includes a machine base 102, a first platen 106 supported by the machine base 102 for carrying a first mold section 106a of a mold, and a second platen 108 supported by the machine base 102 for carrying a second mold section 108a of the mold. The second platen 108 is translatable toward and away from the first platen 106 to close and open the mold. In the example illustrated, a plurality of tie bars 110 extend between the first and second platens 106, 108 for coupling the platens 106, 108 together and exerting a clamp load across the mold when stretched.

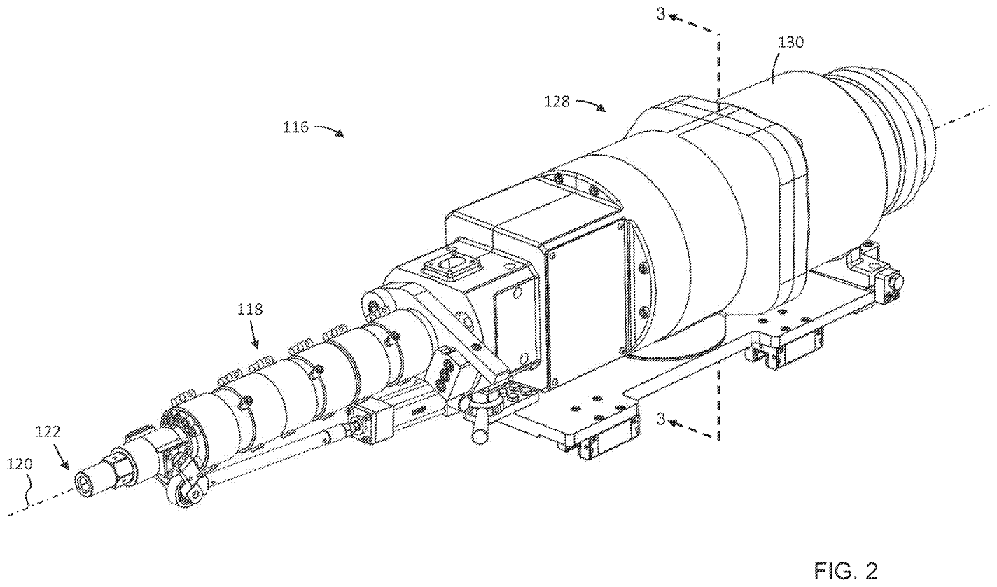

In the example illustrated, the machine 100 includes an injection apparatus 116 supported by the base 102 for plasticizing and injecting resin or other mold material (also referred to as “melt”) into the mold. Referring to FIG. 2, in the example illustrated, the injection apparatus 116 includes a barrel 118 extending along a barrel axis 120 and a nozzle 122 at a front end of the barrel 118 for discharging melt from the barrel 118.

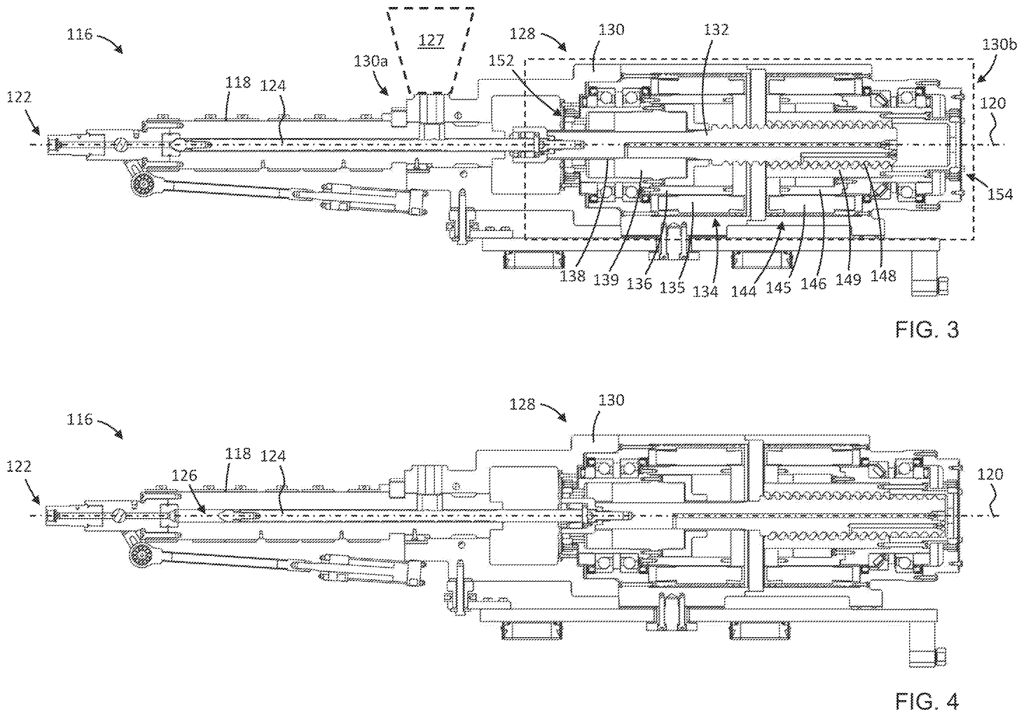

Referring to FIG. 3, in the example illustrated, the injection apparatus 116 further includes a screw 124 in the barrel 118 and extending along the axis 120, and a shot chamber 126 (FIG. 4) in the barrel 118 axially intermediate the screw 124 and the nozzle 122 for holding melt. The screw 124 is rotatable about the axis 120 for plasticizing resin or other mold material (supplied, for example, from a hopper 127) and filling the shot chamber 126 with melt. The screw 124 is translatable along the axis 120 toward and away from the nozzle 122 to alternately load the shot chamber 126 with melt and to inject the melt into the mold.

In the example illustrated, the injection apparatus 116 includes a drive assembly 128 for driving rotation and translation of the screw 124. The drive assembly 128 includes a housing 130 having a front end 130a coupled to the barrel 118 and a rear end 130b axially opposite the front end 130a. The drive assembly 128 further includes a spindle 132 in the housing 130. The spindle 132 extends along the axis 120 and is fixed to the screw 124.

In the example illustrated, the drive assembly 128 includes a first motor 134 in the housing 130. In the example illustrated, the first motor 134 comprises a hollow shaft motor having a first stator 135 fixed relative to the housing 130 and a hollow first rotor 136 through which the spindle 132 passes. The first rotor 136 is rotationally fixed to the spindle 132 for driving rotation of the screw 124 about the axis 120, and the spindle 132 is axially translatable relative to the first rotor 136 for accommodating translation of the screw 124 along the axis 120. In the example illustrated, the spindle 132 comprises a spline portion 138 extending along the axis 120 and the first rotor 136 comprises a spline nut 139 coupled to the spline portion 138 of the spindle 132. In the example illustrated, the spline portion 138 comprises an external spline profile on an exterior of the spindle 132, and the spline nut 139 comprises a complementary internal spline profile on an interior of the spline nut 139.

In the example illustrated, the drive assembly 128 further includes a second motor 144 in the housing 130. In the example illustrated, the second motor 144 comprises a hollow shaft motor having a second stator 145 fixed relative to the housing 130 and a hollow second rotor 146 through which the spindle 132 passes. The second rotor 146 is coupled to the spindle 132 and rotatable relative to the spindle 132 in a rotational first direction for advancing the screw 124 along the axis 120 and in a rotational second direction opposite the first direction for retracting the screw 124 along the axis 120. In the example illustrated, the spindle 132 comprises a ball screw portion 148 extending along the axis 120 and the second rotor 146 comprises a ball nut 149 coupled to the ball screw portion 148.

In the example illustrated, the machine 100 includes a controller 150 (FIG. 1) configured to control operation of the drive assembly 128. In the example illustrated, the controller 150 is operable to control energization of the first and second motors 134, 144 to translate the screw 124 along the axis and/or rotate the screw 124 about the axis 120. The controller 150 is operable to control the axial and rotational velocity of the screw 124 based on the rotational velocity of the first and second rotors 136, 146 relative to each other and the housing 130. In the example illustrated, the controller 150 is operable to control energization of the first and second motors 134, 144 to rotate the second rotor 146 in the rotational first direction relative to the first rotor 136 for advancing the screw toward the nozzle 122; rotate the second rotor 146 in the rotational second direction relative to the first rotor 136 for retracting the screw from the nozzle 122; and rotate the first rotor 136 relative to the housing 130 in the first or second direction for rotating the screw 124 in the first or second direction, respectively, relative to the housing 130.

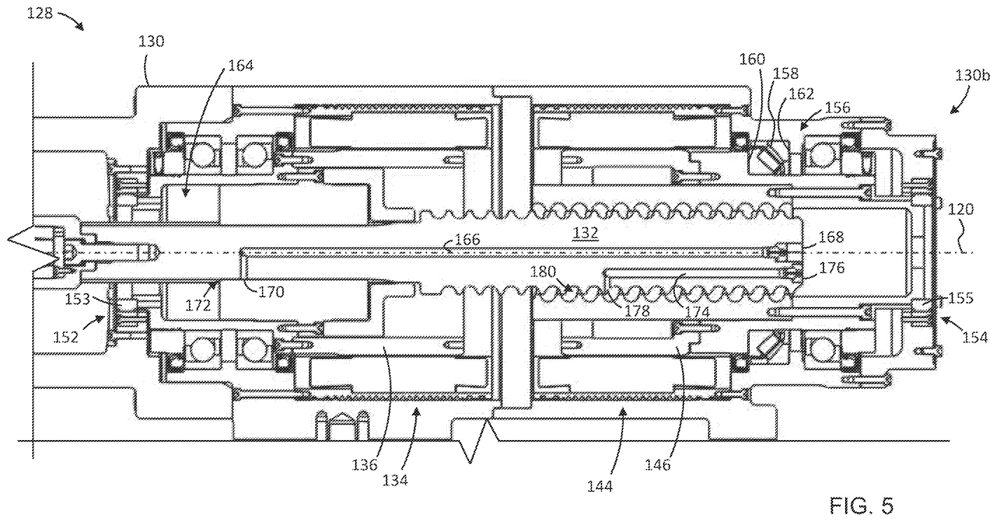

In the example illustrated, the controller 150 is operable to monitor the rotational (angular) and axial (linear) displacement and/or velocity of the screw 124 during an injection cycle based on the rotational displacement of the first and second rotors 136, 146. Referring to FIG. 5, in the example illustrated, the drive assembly 128 includes a rotary first encoder 152 having a first encoder disc 153 mounted coaxially to the first rotor 136 for measuring rotational displacement of the first rotor 136 relative to the housing 130, and a rotary second encoder 154 having a second encoder disc 155 mounted coaxially to the second rotor 146 for measuring rotational displacement of the second rotor 146 relative to the housing 130. In the example illustrated, each of the first and second encoder discs 153, 155 is generally annular and coaxial with the axis 120. In the example illustrated, the spindle 132 passes through at least the first encoder disc 153.

In the example illustrated, the controller 150 is operable to determine a first rotor rotational displacement of the first rotor 136 over a time interval based on output from the first encoder 152 and to determine a second rotor rotational displacement over the time interval based on output from the second encoder 154. In the example illustrated, the controller 150 is operable to determine the rotational displacement and/or velocity of the screw 124 over the time interval based on the first rotor rotational displacement, and to determine the axial displacement and/or velocity of the screw 124 over the time interval based on a differential between the first rotor rotational displacement and the second rotor rotational displacement (and, for example, a pitch of the ball screw portion 148).

In the example illustrated, each of the first motor 134 and the second motor 144 is axially fixed relative to the housing 130, and the second motor 144 is axially rearward of the first motor 134 toward the rear end 130b of the housing 130. Referring to FIG. 5, in the example illustrated, the drive assembly 128 includes a bearing assembly 156 mounted between the second rotor 146 and the housing 130 adjacent the rear end 130b. The bearing assembly 156 accommodates rotation of the second rotor 146 relative to the housing 130 and can transfer at least a portion of a rearwardly directed axial force exerted on the second rotor 146 to the housing 130 (e.g. a rearwardly directed force exerted by the spindle 132 on the second rotor 146 when urging the screw 124 forward against melt). In the example illustrated, the bearing assembly 156 comprises a thrust bearing 158 mounted axially intermediate a rearwardly directed rotor surface 160 fixed relative to the second rotor 146 and a housing surface 162 fixed relative to the housing 130 and directed toward the rotor surface 160.

Still referring to FIG. 5, in the example illustrated, the housing 130 has a generally sealed interior 164, and each of the spindle 132, the first motor 134, and the second motor 144 are generally enclosed in the sealed interior 164. This can help to, for example, contain contaminants that may otherwise be emitted from the drive assembly 128 due to rotation and/or translation of drive assembly components, which may be useful in, for example, clean room applications.

In the example illustrated, the spindle 132 has an internal first conduit 166 extending between a first conduit intake end 168 at a rear of the spindle 132 for receiving lubricant, and a first conduit discharge end 170 open to a first interface 172 between the spindle 132 and the first rotor 136 for discharging the lubricant into the first interface 172. In the example illustrated, the spindle 132 further has an internal second conduit 174 extending between a second conduit intake end 176 at the rear of the spindle 132 for receiving lubricant and a second conduit discharge end 178 open to a second interface 180 between the spindle 132 and the second rotor 146 for discharging the lubricant into the second interface 180.

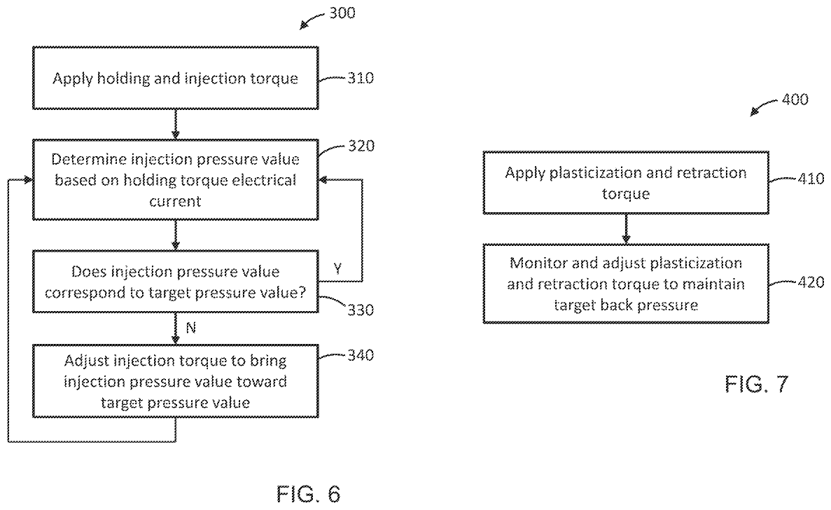

In use, the controller 150 operates the drive assembly 128 to advance the screw 124 axially forward toward the nozzle 122 for injection of a shot of melt from the shot chamber 126 into the mold. In the example illustrated, the controller 150 is operable to control the drive assembly 128 during injection to regulate the melt injection pressure in the shot chamber 126. The melt injection pressure can be regulated by the controller 150 according to, for example, the process 300 shown in FIG. 6.

Referring to FIG. 6, in the example illustrated, at 310 of the process 300, the controller 150 operates the drive assembly 128 to apply a holding torque to the first rotor 136 for inhibiting rotation of the spindle 132 and the screw 124 about the axis 120. The controller 150 further operates the drive assembly 128 to apply an injection torque to the second rotor 146 for exerting an axial force on the spindle 132 to urge the screw 124 to advance toward the nozzle 122. In the example illustrated, the holding torque inhibits undesired rotation of the screw 124 while the injection torque is applied by the second rotor 146. The magnitude of the holding torque is, in the example illustrated, monitored over time and used as an input to facilitate desired control of the injection process, as further explained hereinafter.

The holding torque generally provides a rotationally resistive force on the screw 124 in a direction opposite the direction in which the screw 124 is inclined to rotate as a result of, for example, forces exerted by the second motor 144 and by the melt pressure during injection. In the example illustrated, the screw 124 is inclined to rotate in the rotational first direction as the second motor 144 urges the second rotor 146 to rotate in the rotational first direction. The holding torque is, at least when the screw begins translating from the retracted toward the advanced position, applied in the rotational second direction to resist the rotational force exerted on the screw as a result of rotation of the second motor 144.

In the example illustrated, the holding torque holds the first rotor 136 generally stationary relative to the housing 130 (e.g. brings the rotation of the first rotor 136 to zero or near zero relative to the housing 130), and the injection torque rotates the second rotor 146 in the rotational first direction relative to the first rotor 136 to advance the screw toward the nozzle 122. The holding torque can be selected to limit rotation of the first rotor 136 to a relatively low rotational speed so that the first rotor 136 is generally stationary relative to the housing 130. The low rotational speed can be, for example, under 2 revolutions per minute, or in some examples, under 1 revolution per minute. In some examples, the holding torque can hold the first rotor 136 completely stationary relative to the housing 130 during application of the injection torque (e.g. the first rotor 136 can be rotationally locked relative to the housing 130).

At 320, during application of the holding and injection torques, the controller 150 operates to determine an injection pressure value based on the holding torque. The injection pressure value corresponds to the reactionary pressure of melt in the shot chamber 126 during application of the holding and injection torques. Determining the injection pressure value based on the holding torque may reduce the need for, for example, designated melt-pressure sensors, and may help allow for more precise pressure readings over a wider range of injection pressures relative to some melt-pressure sensors. The magnitude of the holding torque may be made available to the controller 150 directly from one or more sensors, or may be calculated based on parameters indicative of, and/or proportional to, the holding torque.

In the example illustrated, the controller 150 energizes the first motor 134 to apply the holding torque via the first rotor 136, and energizes the second motor 144 to apply the injection torque. In the example illustrated, the controller 150 determines the magnitude of the holding torque based on the amount of electrical current being drawn by the first motor 134 as the first motor 134 applies the holding torque. Holding the first rotor 136 generally stationary during 320 may facilitate a more accurate measurement of the reactionary pressure by, for example, reducing dynamic effects (e.g. acceleration or deceleration torque) on the first rotor 136 that may otherwise affect the amount of electrical current drawn by the first motor 134, independent of the reactionary pressure of the melt.

In the example illustrated, at 330, the controller 150 operates to compare the injection pressure value (as determined in relation to the holding torque) to a target pressure value. The target pressure value corresponds to a target pressure for the melt in the shot chamber 126 during injection. The target pressure value can vary depending on the axial position of the screw 124, for example, to provide a relatively higher target pressure for the melt as the screw 124 nears the end of the injection stroke. In such examples, step 330 includes operating the controller 150 to determine the axial position of the screw 124 relative to the housing 130, and to determine the target pressure value based on the axial position of the screw 124. In the example illustrated, the controller 150 is operable to determine the axial position of the screw 124 based on output from the first and second encoders 152, 154.

Upon determining that the injection pressure value corresponds to the target pressure value, the controller 150 then maintains the holding and injection torques, and optionally proceeds to repeat steps 320 and 330.

If the controller 150 determines that the injection pressure value does not correspond to the target pressure value, then at 340, the controller 150 operates to adjust the injection torque to bring the injection pressure value toward the target pressure value. The holding torque is also adjusted to continue holding the first rotor 136 generally stationary during adjustment of the injection torque.

After adjustment, the controller optionally repeats steps 320 to 340 to continue regulating melt injection pressure during injection. The controller 150 optionally terminates the process 300 in response to detecting one or more termination conditions. The termination conditions can include, for example, the screw 124 completing the injection stroke and/or the reactionary pressure (or its rate of change) falling below a threshold indicating that injection of the melt is complete.

After injection is complete, the controller 150 operates the drive assembly 128 to plasticize melt by rotating the screw 124 while accommodating retraction of the screw 124 to re-fill the shot chamber 126 with melt for a subsequent injection cycle. In the example illustrated, the controller 150 is operable to control the drive assembly 128 during plasticization to regulate the melt plasticization pressure in the shot chamber 126. The melt plasticization pressure can be regulated by the controller 150 according to, for example, the process 400 shown in FIG. 7.

Referring to FIG. 7, in the example illustrated, at 410 of the process 400, the controller 150 energizes the first and second motors 134, 144 to apply a plasticization torque to the first rotor 136 for driving rotation of the spindle 132 (and the screw 124) about the axis 120 to fill the shot chamber with melt, and to apply a retraction torque to the second rotor 146 to control retraction of the spindle 132 (and the screw 124) along the axis 120 during application of the plasticization torque. At 420 of the process 400, the controller 150 operates to monitor and adjust the plasticization torque and the retraction torque to maintain a target back pressure for the melt in the shot chamber 126 during rotation and retraction of the spindle 132 (and the screw 124).

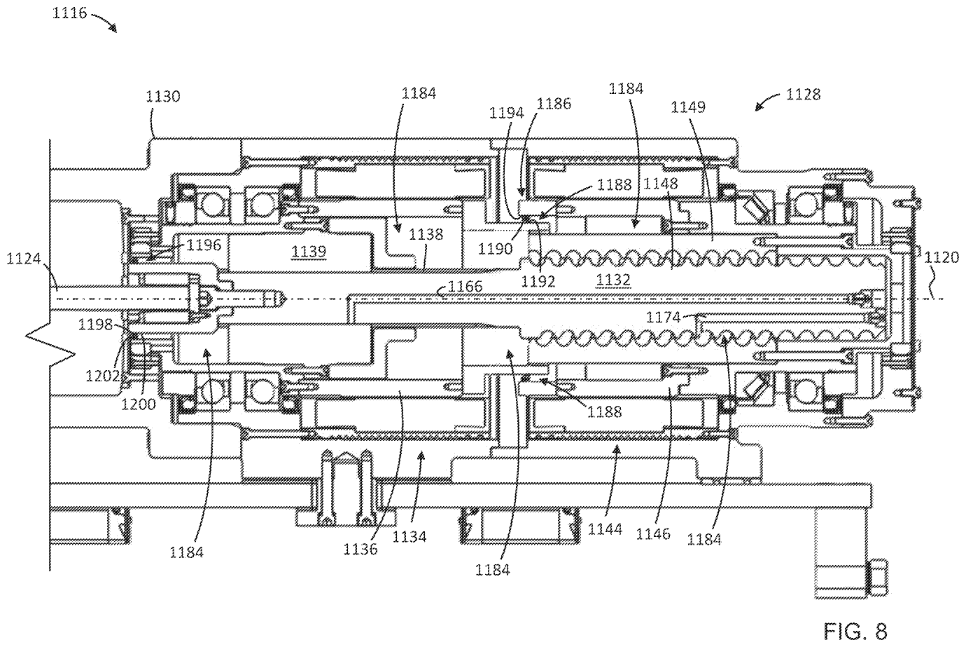

Referring now to FIG. 8, another example of an injection apparatus 1116 is illustrated. The injection apparatus 1116 is similar to the injection apparatus 116, and like features are identified by like reference characters, incremented by 1000.

In the example illustrated, the injection apparatus 1116 includes a barrel extending along a barrel axis 1120 between a nozzle at a front end of the barrel and a drive assembly 1128 at a rear end of the barrel. The injection apparatus 1116 further includes a screw 1124 in the barrel and extending along the axis 1120, and a shot chamber axially intermediate the screw 1124 and the nozzle.

The drive assembly 1128 includes a housing 1130, a spindle 1132 in the housing 1130 and fixed to the screw 1124, a first motor 1134 in the housing 1130 and having a hollow first rotor 1136, and a second motor 1144 in the housing 1130 and having a hollow second rotor 1146. In the example illustrated, the spindle 1132 comprises a spline portion 1138 extending along the axis 1120 and the first rotor 1136 comprises a spline nut 1139 coupled to the spline portion 1138. In the example illustrated, the spindle 1132 further comprises a ball screw portion 1148 extending along the axis 1120 and the second rotor 1146 comprises a ball nut 1149 coupled to the ball screw portion 1148. The drive assembly 1128 can be operated similar to the drive assembly 128 (for example, via the controller 150 according to the process 300 and/or 400).

In the example illustrated, the drive assembly 1128 includes a generally sealed internal chamber 1184 within the housing 1130 for containing lubricant. The internal chamber 1184 includes, in the example illustrated, an axially central portion that extends axially along the spline portion 1138 of the spindle 1132. Lubricant in the central portion of the internal chamber 1184 can help lubricate the connection between the spindle 1132 and the spline nut 1139 along the spline portion 1138.

In the example illustrated, the internal chamber 1184 further includes a rear portion that extends rearward of, and is in fluid communication with, the axially central portion of the internal chamber 1184. The rear portion includes, in the example illustrated, an inner rearward portion that extends axially along the ball screw portion 1148 of the spindle 1132, radially between an outer surface of the ball screw portion 1148 of the spindle and an inner surface of the ball nut 1149. The rear portion of the internal chamber 1184 further includes, in the example illustrated, an outer rearward portion that extends radially outward of an outer surface of the ball nut 1149.

In the example illustrated, the internal chamber 1184 further includes a front portion that is adjacent a font end of the spindle 1132. In the example illustrated, the front portion of the internal chamber 1184 is forward of the spline nut 1139 and the central portion of the internal chamber is rearward of the spline nut 1139. The central portion and front portion of the intern chamber are in fluid communication via longitudinal channels disposed radially between the inner surface of the spline nut 1139 and the outer surface of the spindle 1132.

The drive assembly 1128 includes, in the example illustrated, one or more conduits to provide access to the internal chamber 1184 from outside the housing 1128. In the example illustrated, the drive assembly 1128 includes a first internal chamber conduit 1166 extending from a first conduit outer end at a back of the housing 1130 to a first conduit inner end that is open to the space between the inner surface of the spline nut 1139 and the outer surface of the spindle 1132. In the example illustrated, the drive assembly further includes a second internal chamber conduit 1174 extending from a second conduit outer end at the back of the housing 1130 to a second conduit inner end that is open to the space between the inner surface of the ball nut 1149 and the outer surface of the spindle 1132

In the example illustrated, the drive assembly 1128 further includes a containment seal assembly 1186 to help enclose the internal chamber 1184. This can help prevent lubricant, as well as other materials such as dust or particulate, from egressing from the internal chamber 1184 and from the housing 1128.

In the example illustrated, the containment seal assembly 1186 comprises an inter-rotor seal 1188 adjacent the central portion of the internal chamber 1184, between the first and second rotors 1136, 1146. In the example illustrated, the inter-rotor seal 1188 inhibits dispersion of lubricant radially outwardly from between the first and second rotors 1136, 1146 while accommodating relative rotation therebetween. Providing a seal between the first and second rotors 1136, 1146 (rather than, for example, between each rotor 1136, 1146 and the housing 1130) may help to, for example, reduce the number of parts and/or space required for providing a suitable seal. In the example illustrated, the inter-rotor seal 1188 comprises a first O-ring 1190 held radially between an inter-rotor first seal surface 1192 fixed to the first rotor 1136, and an inter-rotor second seal surface 1194 fixed to the second rotor 1146 and facing the inter-rotor first seal surface 1192. In the example illustrated, the first O-ring 1190 is rotatable relative to at least one of the inter-rotor first seal surface 1192 and the inter-rotor second seal surface 1194 during normal operation.

In the example illustrated, the containment seal assembly 1186 further includes a spindle seal 1196 adjacent the front portion of the internal chamber 1184, and between the spindle 1132 and the first rotor 1136. In the example illustrated, the spindle seal 1196 inhibits dispersion of lubricant from between the spindle 1132 and the first rotor 1136 while accommodating relative axial translation therebetween. In the example illustrated, the spindle seal 1196 comprises a second O-ring 1198 held radially between a spindle first seal surface 1200 axially forward of the spline portion 1138 and fixed to the spindle 1132, and a spindle second seal surface 1202 fixed to the first rotor 1136 and facing the spindle first seal surface 1200. In the example illustrated, the second O-ring 1198 is generally axially fixed relative to the first rotor 1136 during normal operation.

What is claimed is:

1. An injection apparatus for an injection molding machine, comprising:
a) a barrel extending along an axis;
b) a nozzle at a front end of the barrel for discharging melt;
c) a screw in the barrel, the screw rotatable about and translatable along the axis;
d) a drive assembly for driving translation and rotation of the screw, the drive assembly comprising:
i) a housing having a front end coupled to the barrel and a rear end axially opposite the front end;
ii) a spindle in the housing, the spindle extending along the axis and fixed to the screw;
iii) a first motor in the housing, the first motor having a hollow first rotor through which the spindle passes, the first rotor rotationally fixed to the spindle for driving rotation of the screw about the axis, and the spindle axially translatable relative to the first rotor for accommodating translation of the screw along the axis; and
iv) a second motor in the housing axially rearward of the first motor toward the rear end of the housing, the second motor having a hollow second rotor through which the spindle passes, the second rotor coupled to the spindle and rotatable relative to the spindle in a rotational first direction for advancing the screw along the axis and in a rotational second direction opposite the first direction for retracting the screw along the axis.

2. The injection apparatus of claim 1, wherein the spindle has an internal first conduit extending between a first conduit intake end open to a rear of the spindle for receiving lubricant and a first conduit discharge end open to a first interface between the spindle and the first rotor for discharging the lubricant into the first interface.

3. The injection apparatus of claim 1, wherein the spindle has an internal second conduit extending between a second conduit intake end open to a rear of the spindle for receiving lubricant and a second conduit discharge end open to a second interface between the spindle and the second rotor for discharging the lubricant into the second interface.

4. The injection apparatus of claim 1, wherein the spindle comprises a spline portion extending along the axis and the first rotor comprises a spline nut coupled to the spline portion of the spindle.

5. The injection apparatus of claim 1, wherein the spindle comprises a ball screw portion extending along the axis and the second rotor comprises a ball nut coupled to the ball screw portion.

6. The injection apparatus of claim 1, wherein the drive assembly includes a bearing assembly mounted between the second rotor and the housing adjacent the rear end of the housing, the bearing assembly accommodating rotation of the second rotor relative to the housing and transferring at least a portion of a rearwardly directed axial force exerted on the second rotor to the housing.

7. The injection apparatus of claim 1, wherein each of the first motor and the second motor is axially fixed relative to the housing.

8. The injection apparatus of claim 1, wherein the drive assembly includes a rotary first encoder having a first encoder disc mounted coaxially to the first rotor for measuring rotational displacement of the first rotor relative to the housing.

9. The injection apparatus of claim 1, wherein the drive assembly includes a rotary second encoder having a second encoder disc mounted coaxially to the second rotor for measuring rotational displacement of the second rotor relative to the housing.

10. The injection apparatus of claim 1, wherein the housing has a generally sealed interior, and the spindle, the first motor, and the second motor are generally enclosed in the sealed interior.

11. An injection apparatus for an injection molding machine, comprising:
a) a barrel extending along an axis;
b) a nozzle at a front end of the barrel for discharging melt;
c) a screw in the barrel, the screw rotatable about and translatable along the axis;
d) a shot chamber in the barrel axially intermediate the screw and the nozzle for holding melt;
e) a drive assembly for driving translation and rotation of the screw, the drive assembly comprising:
i) a housing having a front end coupled to the barrel;
ii) a spindle in the housing, the spindle extending along the axis and fixed to the screw;
iii) a first motor in the housing, the first motor having a hollow first rotor through which the spindle passes, the first rotor rotationally fixed to the spindle for driving rotation of the screw about the axis, and the spindle axially translatable relative to the first rotor for accommodating translation of the screw along the axis;
iv) a second motor in the housing, the second motor having a hollow second rotor through which the spindle passes, the second rotor coupled to the spindle and rotatable relative to the spindle in a rotational first direction for advancing the screw along the axis and in a rotational second direction opposite the first direction for retracting the screw along the axis; and
f) a controller configured to operate the drive assembly to, for each injection cycle:
i) apply a holding torque to the first rotor for inhibiting rotation of the screw about the axis relative to the housing;
ii) during (i), apply an injection torque to the second rotor in the first direction to exert an axial force on the spindle for urging the screw to advance toward the nozzle;
iii) during (ii), determine an injection pressure value based on the holding torque, the injection pressure value corresponding to a reactionary pressure of melt in the shot chamber during application of the holding torque and the injection torque; and
iv) adjust the injection torque to bring the injection pressure value toward a target pressure value, the target pressure value corresponding to a target pressure for the melt in the shot chamber during injection of the melt into a mold.

12. The injection apparatus of claim 11, wherein the controller is operable to determine the holding torque based on an electrical current required by the first motor to inhibit rotation of the first motor.

13. The injection apparatus of claim 11, wherein the controller is further operable to, prior to (iv), compare the injection pressure value to the target pressure value, and in response to determining that the injection pressure value corresponds to the target pressure value, maintain the holding and injection torques and repeat (ii) and (iii), and in response to determining that the injection pressure value does not correspond to the target pressure value, proceed to (iv).

14. The injection apparatus of claim 11, wherein the controller is further operable to determine the target pressure value based on an axial position of the screw.

15. The injection apparatus of claim 14, wherein the controller is further operable to determine the axial position of the screw based on output from a first encoder for measuring rotational displacement of the first rotor relative to the housing and a second encoder for measuring rotational displacement of the second rotor relative to the housing.

16. The injection apparatus of claim 11, wherein the controller is operable to, after (iv), repeat (ii) to (iv) until detection of one or more termination conditions.

17. A method of operating an injection apparatus drive assembly to regulate melt injection pressure, comprising:
(a) applying a holding torque to a hollow first rotor to inhibit rotation of a spindle about an axis, the spindle passing through the first rotor along the axis and fixed to an injection screw;
(b) during (a), applying an injection torque to a hollow second rotor to exert an axial force on the spindle, the spindle passing through the second rotor along the axis and the axial force urging the injection screw to advance toward a nozzle;
(c) during (b), determining an injection pressure value based on the holding torque, the injection pressure value corresponding to a reactionary pressure of melt in a shot chamber axially intermediate the screw and the nozzle during application of the holding and injection torque; and
(d) adjusting the injection torque to bring the injection pressure value toward a target pressure value, the target pressure value corresponding to a target pressure for the melt in the shot chamber during injection of the melt into a mold.

18. The method of claim 17, wherein (c) includes determining the holding torque based on an electrical current required by the first rotor to inhibit rotation of the first rotor.

19. The method of claim 17, further comprising, prior to (d), comparing the injection pressure value to the target pressure value, and in response to determining that the injection pressure value corresponds to the target pressure value, maintaining the holding and injection torques and repeating (b) and (c), and in response to determining that the injection pressure value does not correspond to the target pressure value, proceeding to (d).

20. The method of claim 17, further comprising determining the target pressure value based on an axial position of the screw, and determining the axial position of the screw based on output from a first encoder for measuring rotational displacement of the first rotor relative to the housing and a second encoder for measuring rotational displacement of the second rotor relative to the housing.
